(19) United States
(12) Patent Application Publication
(10) Pub. No.: US 2011/0035209 A1
(43) Pub. Date: Feb. 10, 2011

(54) Entry of text and selections into computing devices

(76) Inventor: Scott Macfarlane, Manlius, NY (US)

Correspondence Address: Scott Macfarlane, 4677 Watch Hill Road, Manlius, NY, 13104, US

(21) Appl. No.: 12/831,253

(22) Filed: Jul. 6, 2010

Related U.S. Application Data
(60) Provisional application No. 61/223,147, filed on Jul. 6, 2009.

(51) Int. Cl. G06F 17/27; G06F 3/041

(52) U.S. Cl. 704/9; 345/173

(57) ABSTRACT

Aids for improving the use of computing devices incorporating touch sensitive screens and other computing devices, including a method for correcting words incorrectly entered into a computing device which has the steps of: selecting as the word to be corrected one of the one or more words displayed on a computing device display screen during use of text entry software; entering text correction mode and leaving the text entry program; displaying the characters comprising the word to be corrected in such a way that each character can be selected individually by the user; selecting a character to be corrected or deleted, or a character adjacent where a missing character(s) will be inserted; correcting the character selected in the previous step (which can include deleting the character selected) or inserting a character(s); optionally repeating the last two steps to correct additional characters until the word selected to be corrected is changed to a corrected word to which no more changes or corrections need to be made; exiting correction mode and re-entering the text entry program; and replacing the word selected to be corrected with the corrected word.

### CROSS-REFERENCE TO RELATED APPLICATIONS

This application derives and claims benefit from U.S. Provisional Application Ser. No. 61/223,147, filed 6 Jul. 2009, the contents of which are incorporated herein by reference completely in its entirety.

### BACKGROUND

Interacting with computing devices, mistakes are often made. In some cases, the computing devices have touch screen interfaces and mistakes are the result of a lack of congruity between the spot on the touch screen the user intends to press and the spot actually pressed according to the software controlling or operating the touch screen interface. This is in part due to the difficulty a user has in determining exactly the point of contact because his finger obstructs the view of the touch screen so the user is unable to see exactly where he is touching the screen, and in part because the object on the screen the user is attempting to touch (e.g., link, virtual key or button) is sometimes quite small relative to the user's finger (often the user's finger completely obscures the object on the touch screen he or she is attempting to click on). This latter issue is particularly a problem with drop down menus where the spacing between the items in the menu (or list) is tight. There is a need for a better way for a user to determine the exact location of the point of contact between his finger and touch screen, and to make it easier for users to select the correct item in a menu or list of choices, or to select an object on a touch sensitive screen.

In addition, when entering text into a computing device, particularly into a handheld computing device such as a cell phone or PDA with a compact or ambiguous reduced-key set keyboard, mistakes are made. If the mistake is in the middle of a word, correcting the mistake requires either back deleting from the last character of the word and then retyping the word from the corrected character, moving the cursor character by character to the position of the error and making the correction, or using a pointing device to insert the cursor adjacent to the mistake and then make the correction. This is an inefficient way to correct mistakes, especially in long words or in words further back in the text, and the inefficiency is compounded when using a handheld device with a small and limited function keyboard. In addition, handheld devices often use predictive text (PT) algorithm software to guess the word being entered by the user, and often the word guessed is wrong. Some PT software guesses a complete word from a limited set of entered characters, often providing a list of complete words from which to choose. Unfortunately, and especially with small touch sensitive screens, it is easy to select the wrong word from the list of choices, necessitating the erasure of the selected word up to the first correct character. This is inefficient. There is a need for a better way for users to correct errors in text entry.

### SUMMARY

One aspect of the present invention is an efficient method of correcting words incorrectly entered into a computing device by allowing a user to go directly to the mistake. Note that a word is any string of one or more characters preceded and followed by a space or a punctuation mark. Text entry on a computing device is done while using a text entry program. Computing devices include smart phones, personal digital assistants (PDAs), tablet computers, dedicated gaming machines such as Sony Playstation and Nintendo Gameboy, laptop computers, desktop computers, netbooks, cell phones, and any other electronic device incorporating a central processing unit or the equivalent. In one embodiment, the method comprises the steps of: selecting as the word to be corrected one of the one or more words displayed on a computing device display screen during use of text entry software; entering text correction mode and leaving the text entry program; displaying the characters comprising the word to be corrected in such a way that each character can be selected individually by the user; selecting a character to be corrected or deleted, or a character adjacent where a missing character(s) will be inserted; correcting the character selected in the previous step (which can include deleting the character selected) or inserting a character(s); optionally repeating the last two steps to correct additional characters until the word selected to be corrected is changed to a corrected word to which no more changes or corrections need to be made; exiting correction mode and re-entering the text entry program; and replacing the word selected to be corrected with the corrected word. This method can be implemented in software that can run on any computing device that can be used for word processing or other application comprising the act of entering text. One aspect of the present invention is a computing device, including a handheld computing device such as a cell phone and PDA, operating text entry software which enables the efficient correction of incorrectly entered words according to the previously described method. In some embodiments, the handheld computing device comprises a key which can be operated to cause the text entry software to enter a correction mode. Such key can be a virtual key or field on a touch-sensitive display screen or physical key.

Another aspect of this invention is for computing devices with touch sensitive displays and comprises virtual buttons for selecting items in menus or lists which feature areas of the touch sensitive display adjacent to the menu item that enlarge the virtual button to make it easier to make the selection without error.

Another aspect of this invention is also for computing devices with touch sensitive displays and comprises a graphic in the form of at least two intersecting elements (or elements that imply intersection) that indicate the location of the point of contact between the user's finger and the touch screen, or in some cases the virtual button that the finger is contacting (such as a virtual keyboard key).

Another aspect of this invention is a display insert or window for a touch sensitive display that displays the area surrounding a point of contact registered by the computer (for example, of a finger or pen). The inserted window is positioned elsewhere on the display where it is not obstructed by the object in contact with the touch screen, such as in an upper corner of the display, and displays that part of the display proximal to the point of contact and which is often obscured. For example, in one embodiment, the display insert shows a square area 99 pixels by 99 pixels, the center of which is the calculated point of contact (or the center of the detected area of contact) between a finger or pen, for example, and the touch screen. The image in the display insert is the same as that surrounding the point of contact and enables a person to clearly see the part of the touch sensitive display that may be obscured by the finger being used to touch the screen. In one embodiment, a graphic, such as a crosshairs or a point or a small circle, indicates the point of contact or center of the area of contact.

### BRIEF DESCRIPTION OF THE DRAWINGS

FIGS. 1A-1B are top views of the correction mode implemented on a smart phone having a full, miniature QWERTY keyboard.

FIGS. 2A-2G are sequential views of the display of a smart phone having a touch screen interface and a full virtual QWERTY keyboard showing what a user sees while using correction mode to make a correction in text.

FIGS. 3A-3L are views of the display, or portions thereof, of a smart phone having a touch screen interface and a virtual reduced key compact keyboard showing what a user sees while using correction mode to make a correction in text.

FIGS. 4A-4H are views of the display of a phone having a 12-key phone keypad for text entry showing what a user sees while using correction mode to make a correction in text.

FIGS. 5A-5B are views of the display of a touch screen showing how the area of a clickable menu item is increased in size.

FIGS. 6A-6D are views of the display of a touch sensitive display showing graphics that allow a user to more accurately determine where he or she is actually touching the display.

### DETAILED DESCRIPTION OF THE INVENTION

The invention described here includes improved methods of entering text and otherwise interfacing with a handheld or other computing device.

The invention includes an improved method for correcting words entered into a computing device, particularly into handheld computing devices, software for computing devices that causes the computing device to operate according to the improved method for correcting computing devices operating according to the improved method, and computing devices comprising a means, such as a key, virtual or physical, for triggering the improved method for correcting words. The method comprises the steps of selecting a word (a word is a string of characters) to be corrected from among one or more words displayed on the computing device display screen during the entry of text using a text entry program; entering text correction mode and exiting the text entry program (or leaving text entry mode of the text entry program and entering correction mode); displaying the text characters comprising the word selected for correction so that each character can be individually and directly selected by a user; selecting a text character to be corrected or otherwise changed, or which is adjacent to a correction to be made (such as by insertion); correcting or otherwise changing the selected text character or inserting a character(s); optionally repeating the steps of selecting a character in the word and making a correction until the word selected for correction is completely corrected (the corrected word); exiting correction mode and re-entering the text entry program (or re-activating text entry mode of the text entry program); and replacing the word selected to be corrected with the corrected word.

This method can be implemented in software or hardware. In software, it can be a standalone program that is activated and inactivated by the user when needed, or it can be a sub-program that is part of the software operating the keyboard or the software for text entry or word processing. It can be implemented in software in any programming language. The software will run on any computing device having a keyboard and a display. Some embodiments will run only on computing devices having touch sensitive display interfaces.

Selecting a word to be corrected can be done by the user or can be automatic. Various ways that a user can select a word for correction include by highlighting a word or by placing the cursor among the characters of a word. A word can automatically be selected for correction by the device; for instance, if the cursor is not within a word and no word is highlighted when correction mode is entered or activated, then the device, or its software, will select the word which the cursor is immediately following. One way is that the word correction software will select whichever word the cursor is in or is immediately after at the time correction mode is activated.

In one embodiment, whenever the computer detects a misspelled word, that word is automatically displayed as described below. The user can then make a correction or, if the word is actually spelled as desired, can immediately exit correction mode.

The means for entering text correction mode can include: pressing a dedicated key in a physical or virtual keyboard; pressing a dedicated icon, button or key on a touch-sensitive display; pressing a soft key (a physical key or button that can be assigned more than one function) assigned to that function; pressing and holding a specific key (such as the Delete key or a virtual key on a touch sensitive display) that is programmed to recognize such action and trigger correction mode after detecting such action (an action other than pressing and holding can be used, such as pressing a certain sequence of keys—ex. pressing space, the letter ‘c’, space; chording of keys or buttons can also be used); selecting correction mode from a menu (such as a right click drop down menu or a menu brought up by pressing a key or button); pressing on the text being entered in the text field shown on the touch sensitive display; or any of the other means used on computing devices to change modes. Another means of entering text correction mode appropriate to a computing device with a touch-sensitive display can be to press and hold on the word to be corrected, or to select the word and then press down anywhere on the touch-sensitive display and hold until correction mode is activated.

There are multiple ways to display the text characters comprising the word being corrected so that each can be individually and directly selected by the person entering text. The way the characters are displayed determines the means by which characters are selected for correction or change. One way to display the text characters comprising the word being corrected so that each can be directly selected that is appropriate for devices having touch-sensitive displays is to display each text character as a separate, virtual button or key on the touch-sensitive display. In this case, the user selects a character to be corrected or changed by pressing or otherwise engaging the virtual button or key for that character of the word being corrected.

Another way to display the text characters comprising the word being corrected so that each can be directly selected that is appropriate for devices with numeric keypads is to display at least the first ten characters of the word, preferably in their order in the word, such that each is associated with a number between 1 and 10 (as represented by the 0 key; or 0-9). The number can be associated with the character by being displayed above or below it or by being connected to it graphically in some way or by some other means. In this case, the user presses the number key associated with the character he or she wants to correct or otherwise change. For example, if the user wants to change the second character in a word, and this character is associated with the number 2, he would press the 2 key.

Another way to display the text characters comprising the word being corrected so that each can be directly selected that is appropriate for devices incorporating a keyboard of any size and any number of keys is to display the characters so that they are physically associated with one of the keyboard's keys. One way this can be accomplished is by aligning each displayed character above one of the keyboard's keys. Alternately, the characters can be displayed on a virtual representation of the device's keyboard so that the user can easily see which key to press to select which character. In this case, the user selects the character to be corrected or otherwise changed by pressing the indicated key. In one embodiment for a computer with a full keyboard, the function keys are used to select the character in the word that is to be corrected or which is adjacent to the correction to be made, and each character in a word to be corrected is associated with one of the function keys by one of the means described above.

Preferably, once a character is selected to be corrected or otherwise changed, the fact that that character is selected is indicated graphically in some way, such as by highlighting the character, making it bold, underlining it, assigning it a special graphic or by some other means.

How the selected character is corrected or otherwise changed also depends in part upon the device into which the word is being entered. Also, in some cases, there may be an extra character in the word being corrected which needs to be deleted. In some cases, there may be a missing character which needs to be inserted. With most devices of the present invention, once a character is selected, the device's keyboard can be used as it is normally used to replace or delete the selected character, or to insert a new character (this may require that correction mode include an insert function that can be triggered by pressing a dedicated key, a soft key or by some other means). In one mode of operation, so long as a particular character in the word is selected, it can be changed by operating the keyboard. To change another character of the word being corrected, the user must first select that other character, then operate the keyboard to change it. Thus if the first replacement character is entered incorrectly, the user can simply operate the keyboard a second time to enter the correct replacement character.

Unlike many of the 12 keys of phone keypads which are used to enter four or five or more characters each, not counting capital letters, the keys of the RIM SureType keyboard are used to enter only two characters each. SureType keyboards operate under predictive text software which tries to guess which of the two characters that can be typed using a particular key is the one intended. Sometimes the predictive text software guesses wrong. Since there are only two choices for the predictive text software, if the current character displayed is wrong, the other character entered using that key is most likely the correct one (it could be that neither is correct because the user pressed the wrong key). Therefore, with the RIM SureType keyboard (real or virtual), the selection of the character in the word being corrected provides enough information for the software to make the correction itself. If the correction made by the software is wrong, the user can then use the keyboard to enter the correct character or otherwise change the word at that point. This can also be an optional mode of operation, selectable in advance by the user.

This approach of having the predictive text software make a guess upon selection of a character can be extended to other keyboards, both multitap keyboards such as the phone keypad or full keyboards. With the phone keypad, the guesses of the predictive text software can be limited to the other characters entered using the same key as the selected character. With full keyboard, the guesses can be limited to keys adjacent to the key used to enter the selected character. If the keyboard software has the capability to make a guess when a character is selected, it may be advisable to have two types of selection, one in which the character is selected and a guess is automatically made (perhaps a quick press of a key) and one in which the character is selected and no guess is made by the software (perhaps indicated by pressing and holding the key for selecting the character). This capability may also be one that can be turned off or on according to user preferences.

If there is more than one error in the word being corrected, the user can repeat the steps of selecting a character to be corrected and then changing or correcting that character until the incorrect word (the word selected for correction) is corrected (the corrected word). The user can also, in preferred embodiments, insert new characters. In one preferred embodiment, whenever a correction is made, all characters in the word that are to the left of the character just corrected (i.e., that precede that character in the word) are assumed to be correct. In this embodiment, the user should correct mistakes in the word starting from the mistake closest to the start of the word and moving towards the end of the word. If the device is running predictive text software, that software may make a new guess based on the corrected character and all the characters to the left of it that are assumed to be correct, and if the guess is correct, the user can then exit correction mode.

At the appropriate time, such as when all characters have been corrected and the word to be corrected has been changed to the corrected word, the user exits correction mode to resume text entry by some means. One means of exiting correction mode is for the user to press the correction key (real or virtual) once. In this case, pressing the correction key once activates correction mode, and pressing the correction key a second time exits or inactivates correction mode and returns the user to the previous application or screen (such as a text messaging, address book or email screen or application) to continue text entry.

In some cases, particularly where the keyboard software has word completion functionality, the selected word to correct may have so many errors that the user wants to correct only a part of the word. For example, the user may be trying to type ‘preview’ and have entered the first four letters only (‘prev’). When the user in this example tried to select ‘preview’ from the guesses of the keyboard software, he accidentally selected and entered the word ‘previously.’ In this example, the user may want to indicate that the first five characters (‘previ’) are correct and then go back to text entry mode where only ‘previ’ will show as having been entered. Once in text entry mode, the user can either complete the word by entering an ‘e’ and a ‘w’ or select ‘preview’ from a list of word guesses proffered by the software. There are several ways to accomplish this. One way is for the correction mode software to truncate the word being corrected after whichever character is selected at the time correction mode is exited. Using the previous example, the user would select the ‘i’ and then exit correction mode. Alternately, the user could select the ‘o’, replace it with an ‘e’ using the keyboard, and then exit correction mode; in this case the word would be truncated after the ‘e’ (in this case, the five letters ‘previe’ would be returned to the text entry screen as the corrected word). Another way is for the pressing and holding of the key or button that selects a character to cause the correction mode software to exit correction mode and return to the text entry screen only the characters up to and including the selected character as the corrected word. In this latter case, any automatic correction of a character that would normally have occurred upon selection of that character by the user will not be done if the user presses and holds whichever key, icon or field that must be pressed to select that character. Other ways to identify the last correct character in a word being corrected and truncate the word after that character will occur to those skilled in the art of keyboard software. The ability to truncate a word being corrected may be one of several configurations of correction mode software. Upon exiting correction mode and returning to text entry, the predictive text software would make another guess based upon the characters returned.

Upon exiting correction mode and re-entering text entry mode, the incorrect word that was selected in the first step to be corrected is deleted and replaced by the corrected word.

Correction mode can be enabled by a subroutine or sub-program within a text entry software program, by a separate software program, by the operating software for a peripheral (such as a keyboard), or by a subroutine or sub-program within other application software (such as an email program). The software runs on a computing or other microprocessor controlled device to enable a user of the device to correct text being entered into that device for some purpose.

Computing devices have multiple means of text entry. Desktop and notebook computers have alphanumeric keyboards. Microprocessor-controlled devices like many fax machines and copiers often have virtual keyboards. Handheld computing devices have multiple means of text entry. Some devices, such as the Blackberry Curve and Palm Treo, incorporate a keyboard with one key per letter. Other devices, such as many cell phones, incorporate a 12-key phone keypad which can be used for text entry, but which does not have one letter to one key correspondence; rather, each of the keys of a 12-key phone keypad used to enter letters of the alphabet is used to enter multiple letters plus a number. 12-key phone keyboards can be typically by operated in both multitap mode, wherein the user taps a key a certain number of times to enter a particular character entered using that key, and in predictive text mode, wherein the user only taps a key once per character to be entered and the text entry software, which incorporates some sort of predictive text functionality, guesses which of the several characters that can be entered using the presssed key is the intended character. There are other types of compact keyboards, such as RIM's SureType keyboard, that assign multiple letters to individual keys. Other handheld computing devices have a touch screen interface. To enable text entry on these devices, a virtual keyboard is displayed on the screen. This virtual keyboard can have a layout of keys equivalent to any physical keyboard or can have a different layout. The virtual keyboard comprises virtual keys, and touching the touch-sensitive display appropriately over the virtual key has the same effect as pressing the key of an electro-mechanical keyboard. There are a wide variety of keyboards and keyboard layouts for computing devices, microprocessor-controlled devices, and computing device peripherals, such as the aforementioned and DVORAK and QWERTY, etc. There is also a wide variety of keyboards and keyboard layouts for such devices intended for use in entering text in non-English languages. The present invention applies to correcting text entered using any such keyboards and keyboard layouts, with appropriate adjustments.

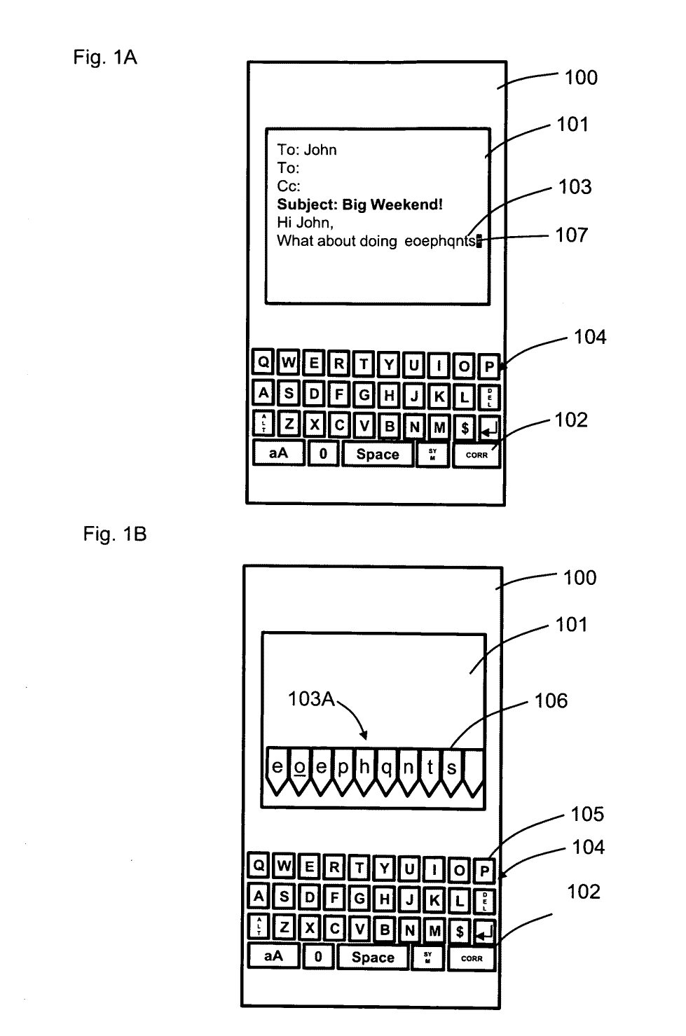

Implementation of the invention varies depending upon the type of text entry interface incorporated into or used by the computing device. In FIG. 1A is shown an illustration of a handheld computing device 100 comprising a display 101, a full mini keyboard 104 with one key per letter, and a CORR key 102 for entering correction mode. The user is entering the word ‘elephants’ but mistypes it ‘eoephqnts’ by hitting the wrong keys (the keys of devices like this—shown is a BlackBerry Curve—are small, and it is easy press the wrong key when typing). In order to correct the spelling, the user presses the CORR key 102 to enter correction mode. The word to be corrected 103 is either the word in which the cursor is or, if the cursor is not in a word, the word immediately preceding the cursor or the word highlighted at the time correction mode is entered. Thus, the user can simply press the CORR key 102 immediately after mistyping a word to correct that word, or he can actively select a word previously entered to be corrected.

FIG. 1B shows an illustration of smart phone 100 after correction mode has been activated. In correction mode, the word selected for correction 103 is displayed as word 103A with one letter aligned roughly above each of the keys in the first or top row 105 of the keyboard 104. Optional graphics 106 are provided around each displayed letter to emphasize that alignment, including an empty graphic above the rightmost key as there are only nine letters in the word 103A being corrected. Graphic 106 is shaped like a rectangular stake with a triangular point at the lower end that points at one of the key in the top row 105; the graphic 106 is labeled with the character associated with that key. If there are more than 10 characters in a word being corrected, the word can be truncated at 10 characters or the word can wrap around into a second row of characters, with the characters in the second row associated with a key in the second row of the keyboard 104. The characters of the word 103A—e, o, e, p, h, q, n, t and s are associated respectively with the q, w, e, r, t, y, u, i and o keys of the top row 105. The word 103 was selected automatically in this case as the word immediately preceding the cursor 107 (see FIG. 1A). If the user wanted to correct a word other than the last word in the text being entered, then prior to pressing the correction key 102, the user would move the cursor 107 into or immediately after that other word so that it is specified as the word to be corrected when correction mode is activated.

The user then selects a text character to be corrected or otherwise changed. In this case, the second letter is ‘o’ but should be ‘l’. The user selects a character in the word 103 being corrected by pressing the key in the first row 105 of the keyboard 104 aligned below that character, in this case the W key (the second key in the first row 105 from the left). After a character is selected, it will preferably by identified as selected in some way, such as being underlined as shown in FIG. 1B or highlighted in some other way. Next, the user uses the keyboard 104 to correct or otherwise change the selected character. The ‘o’ can be replaced with an ‘l’ by operating the l-key, but it could be replaced by any other character the keyboard 104 is capable of entering, or it could be deleted. In some cases, the mistake in spelling may involve a missing character, in which case the user can select a character, then use an insert function (which may be activated in some cases by a keyboard key or using one of the soft keys) to insert a space in front of the selected character which then becomes the selected character so that it can be replaced by another character entered using the keyboard 104.

After correcting the ‘o’, the user can correct the ‘q’ (the sixth letter in the misspelled word 103) by first selecting the ‘q’ by pressing the Y key (the sixth key from the left in the top row 105 which is aligned under the graphic labeled ‘q’) and then replacing the ‘q’ with an ‘a’ by pressing the A key. The word is now correctly spelled. The user exits correction mode by pressing the CORR key 102 again, returning to the previous application, screen or window.

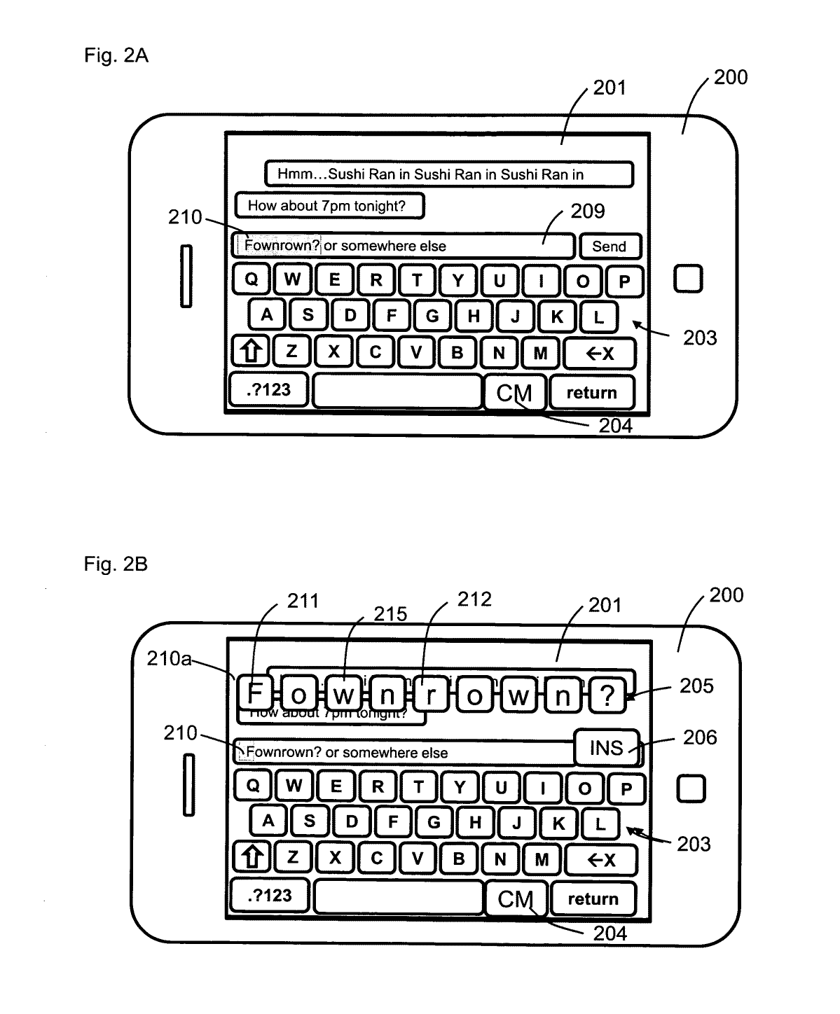

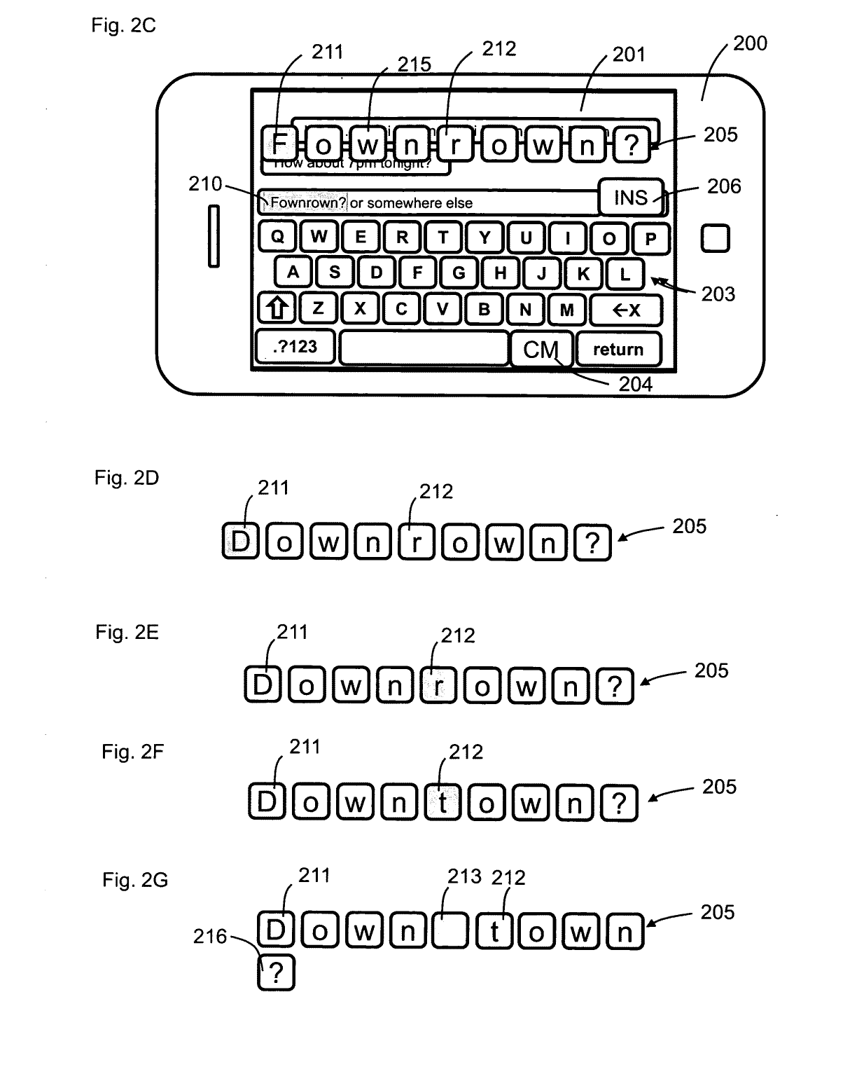

FIG. 2A shows an illustration of the front side (the side containing the touch sensitive display) of a handheld computing device 200 such as a smart phone (e.g., an Apple iPhone®) or other device (e.g., an Apple iTouch® or BlackBerry Storm) comprising a touch-sensitive display 201 and a virtual keyboard 203 displayed on the touch-sensitive screen 201. The virtual keyboard 203 is a full QWERTY keyboard (it can be any type of keyboard in any language) and comprises a correction key 204 labeled ‘CM.’

A user is entering a word 210 into a text entry field 209 using the virtual keyboard 203. He or she intended to enter the word ‘Downtown?’ but hit the wrong keys and misentered it as ‘Fownrown?’. To correct the word 210, the user selects the word 210 that is to be corrected (in FIG. 2A, the word 210 has been selected as shown by the highlighting—it was not the last word in the text entry field and so the user had to select it directly), and then presses the CM key 204 to enter or activate correction mode of the software. FIG. 2B shows the device 200 after the user has activated correction mode. In correction mode, the word 210 being corrected is displayed as a correction mode (CM) word 205 which is a set of separate virtual keys or buttons 215 that spell out the word 210. The CM word 205, comprising the virtual keys or buttons 215, can be displayed anywhere on the screen 201. To select a character for correction, the user simply presses one of the virtual keys comprising the CM word 205, and then uses the keyboard 203 to enter the correct character. There is also a virtual insert key 206 labeled INS which the user can use to insert a character in front of the character selected by pressing that character's key. The user can also use the delete key of the keyboard 203 to delete the selected character.

FIGS. 2B to 2F illustrate, as an example, how the word 210 ‘Fownrown?’ would be corrected (FIGS. 2D-2E show only the CM word 205 spelling out the word being corrected 210, and not the entire device 200). The user presses the CM key 204 to activate correction mode and, as shown in FIG. 2B, the word 210 is displayed as a CM word 205 comprising a set of virtual keys 215, with each character having its own key and the keys aligned horizontally (if the language being used has another orientation of characters in a word, such as up to down or right to left, the keys, and the characters associated with each can be in that orientation) with the characters arranged in the same order as in the word 210 on the text entry screen. For long words, the CM word 205 may wrap around into a second row of virtual keys 215.

To select a character for correction, such as the ‘F’ (the first letter in word 210 and first key in CM word 205), the user presses on the key 211 associated with the F (i.e., the virtual key labeled ‘F’ 211). In this example, as shown in FIG. 2C, a plan view of the front of device 200, selecting a character causes both the virtual key 211 associated with the character in the CM word 205 and the character in the word 210 in the text entry line to be highlighted. The user then uses the keyboard 203 to replace the ‘F’ with a ‘D’; the resulting change to the CM word 205 is shown in FIG. 2D (only the CM word 205 is shown). The user then selects the ‘r’ (the other incorrect character in word 210) by pressing the virtual key 212 of the CM word 205 (which is labeled ‘r’); key 212 is then highlighted (the result is shown in FIG. 2E, which also shows only CM word 205). Once the appropriate character is selected for changing, the keyboard 203 is used to enter a ‘t’ to replace the ‘r’ (the resulting change to the CM word 205 is shown in FIG. 2F). The word is now correct, and the user can exit or inactivate correction mode by some means, such as by pressing the CM key 204, and return to text entry mode. Upon return from CM mode, the corrected word “Downtown” will replace the word 210 “Fownrown” in the text entry field 209 in the same place in the phrase being entered (i.e., before ‘or somewhere else’).

FIG. 2G shows what would have happened if the user had wished to insert a character into word 210 while in correction mode. First, the user would select the character that will follow the character being inserted by pressing on the appropriate key 215 of CM word 205, then press the INS virtual key 206. A new virtual key with no label (or labeled as a space) will be displayed at the point in the CM word 205 where the new character is to be inserted, and the keys for all characters following the newly inserted key will be moved away from the front of the CM word 205 to create space for it. This is shown in FIG. 2G which shows only the CM word 205. The (‘t’) key 212 that will follow the inserted character was

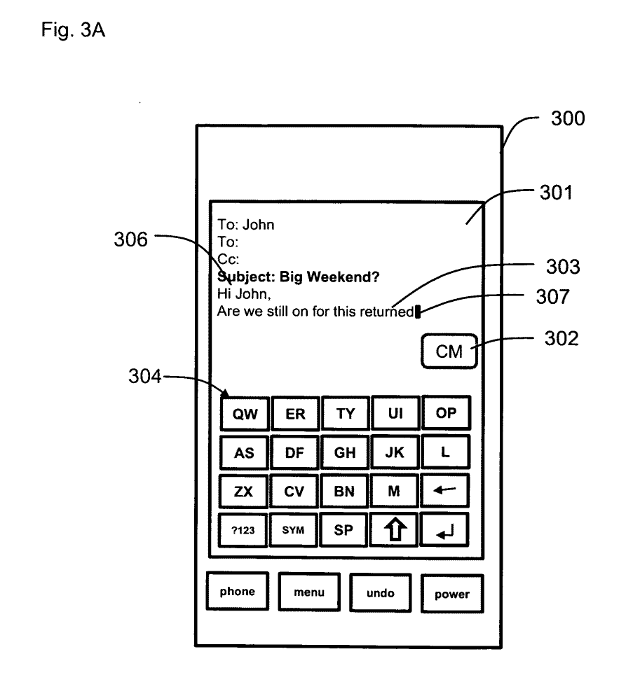

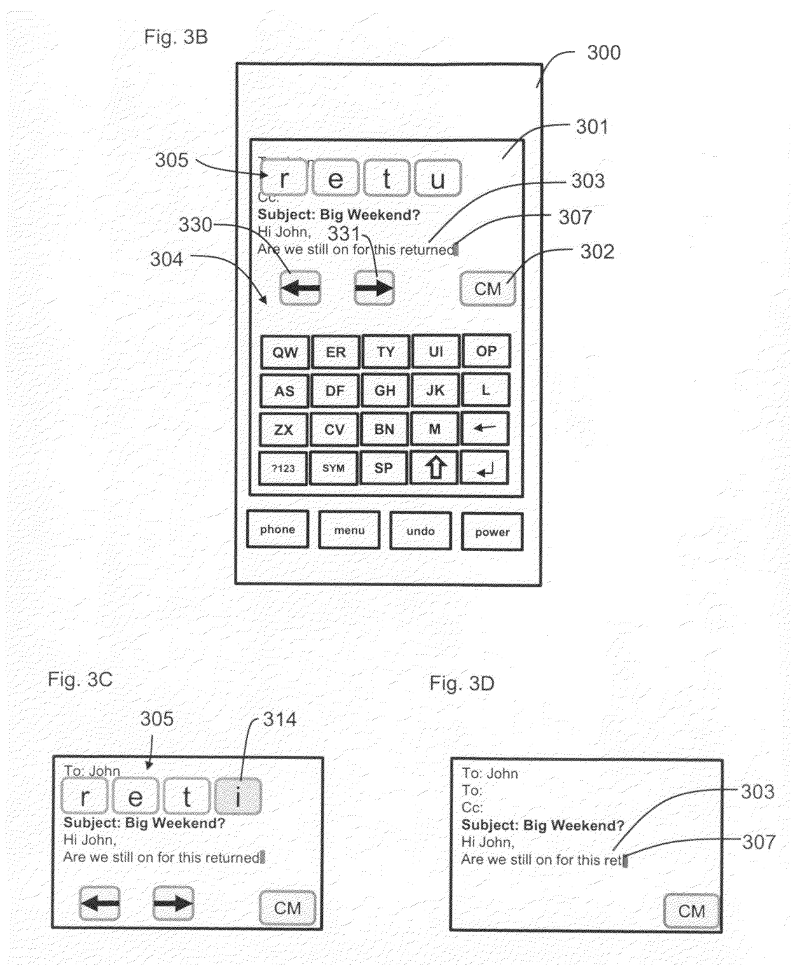

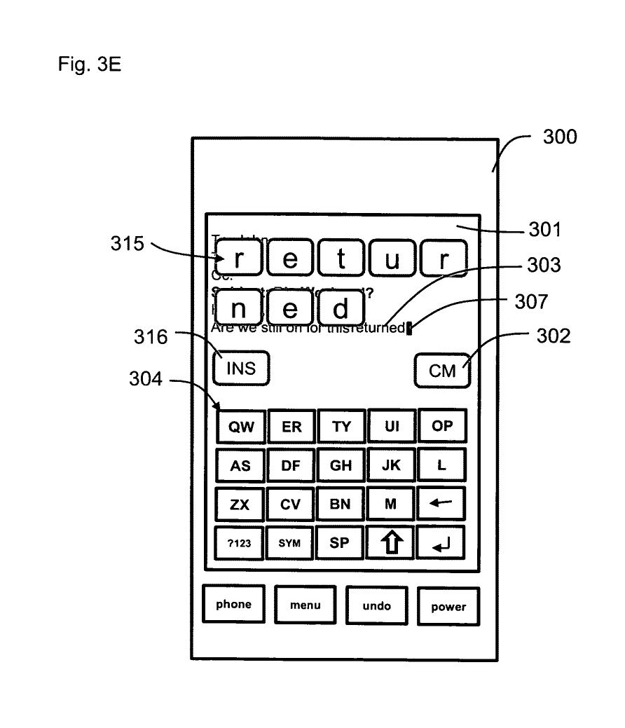

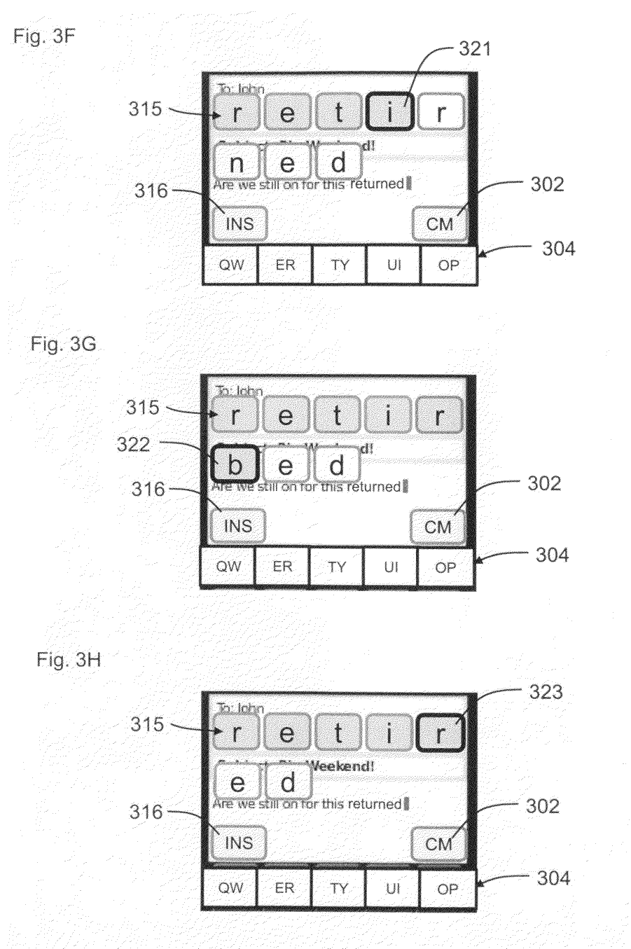

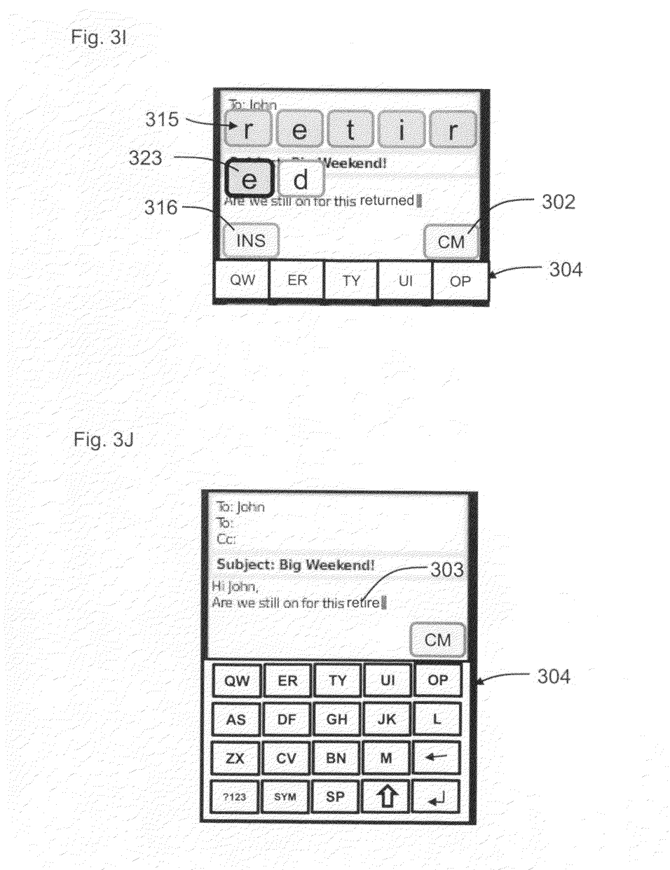

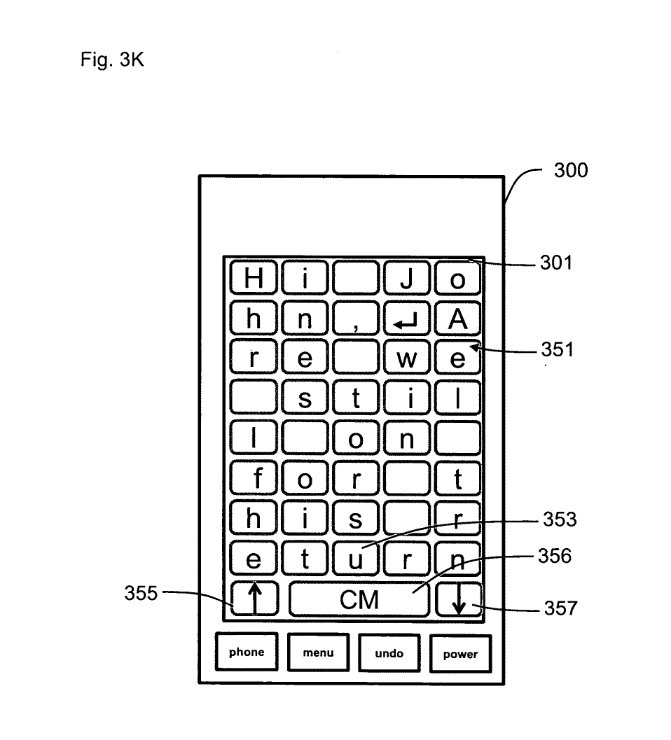

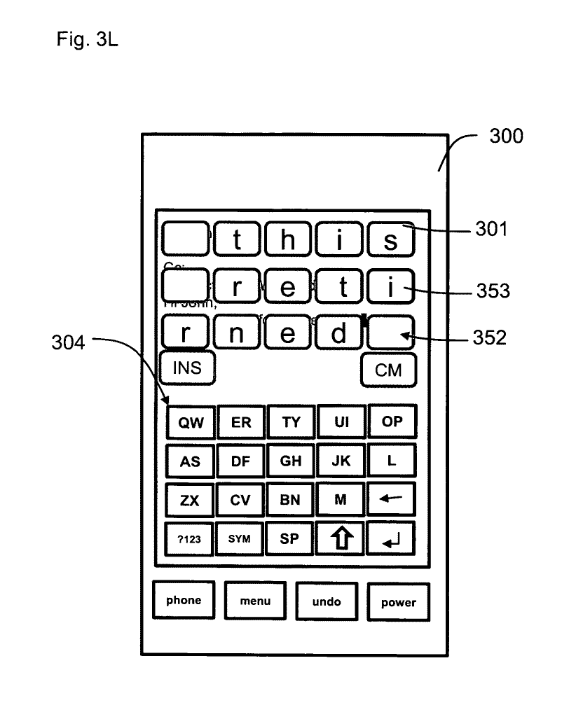

FIG. 3A is an illustration of computing device 300 operating according to the present invention comprising a touch-sensitive display 301 and a SureType® virtual keyboard 304 displayed on the touch-sensitive display 301. The actual device shown is a BlackBerry Storm®. The SureType keyboard has twenty keys arranged in four rows of five keys each. The English version has the letters of the alphabet assigned in QWERTY order, left to right, starting with the top row of keys, with two letters assigned to each key until there are no more letters to assign in that row. The three letter row's five keys, left to right, enter the following pairs of letters respectively: top row—Q and W, E and R, T and Y, U and I, and O and P; second row—A and S, D and F, G and H, J and K, and L; and the third row—Z and X, C and V, B and N, and M. Keys not used for letters are used for other purposes such as Enter, backspace delete, shift, space, and to bring up other keyboards for numbers, punctuation and symbols.

The keyboard 304 optionally contains a dedicated key 302 (labeled ‘CM’ in FIG. 3A-3D) for entering or activating correction mode. A user may enter correction mode by pressing on the CM key 302, or in another embodiment by pressing and holding the display 301 directly on one of the words already entered into the text field 306. In another embodiment, the delete key doubles as the CM key, and pressing and holding the delete key causes the device 300 to enter correction mode.

In the following, two modes of operation of correction mode are described. The first mode is described using FIGS. 3A-3D as illustrations and using an example of a user attempting to enter the word ‘retirement’. The SureType software includes predictive text functionality, and the software attempts to guess the word being typed from the keys already pressed. FIG. 3A shows the result after a user of device 300 has typed in only four characters by pressing the virtual keys ER, ER, TY and UI keys in that order. With that input, the SureType predictive text algorithm offered a number of guesses in a drop-down menu or list from which the user could optionally select one guess as correct by pressing the touch-sensitive display 301 at the point where the desired selection is displayed. Unfortunately, people's fingers are big and the intended selection is not always the one that actually gets pressed. That is the case in this example; the user intended to select ‘retirement’ from the list of guesses provided by the text-entry software, but mistakenly pressed and chose ‘returned’ instead. Now he wants to correct the word without erasing all the letters after ‘ret’.

First, the user selects the word to be corrected. In this case the incorrectly entered word is the last word typed and so the cursor is immediately after it, and since it is the word that will automatically be selected by the correction software, the user does not need to do anything to select the word to be corrected. Next, the user presses the correction mode CM key 302 to enter correction mode. If the CM key is pressed, the software will select as the word to be corrected the word in which the cursor is currently located or immediately preceding the cursor, if the cursor is not in a word. FIG. 3B is a front plan view of device 300 showing the display after correction mode of the text-entry software has been activated. In this first mode of operation, only the character guesses associated with an actual key press are displayed as virtual buttons in the correction mode or CM word 305. In this example, only four keys have been pressed (including the ER key twice), so only the first four characters of the word 303 are shown, r, e, t and u as the correction mode word 305. Each of the four characters is displayed as one of a set of individual virtual keys 305, each key labeled with the appropriate character in word order; thus there are four keys labeled, in word order, r, e, t and u.

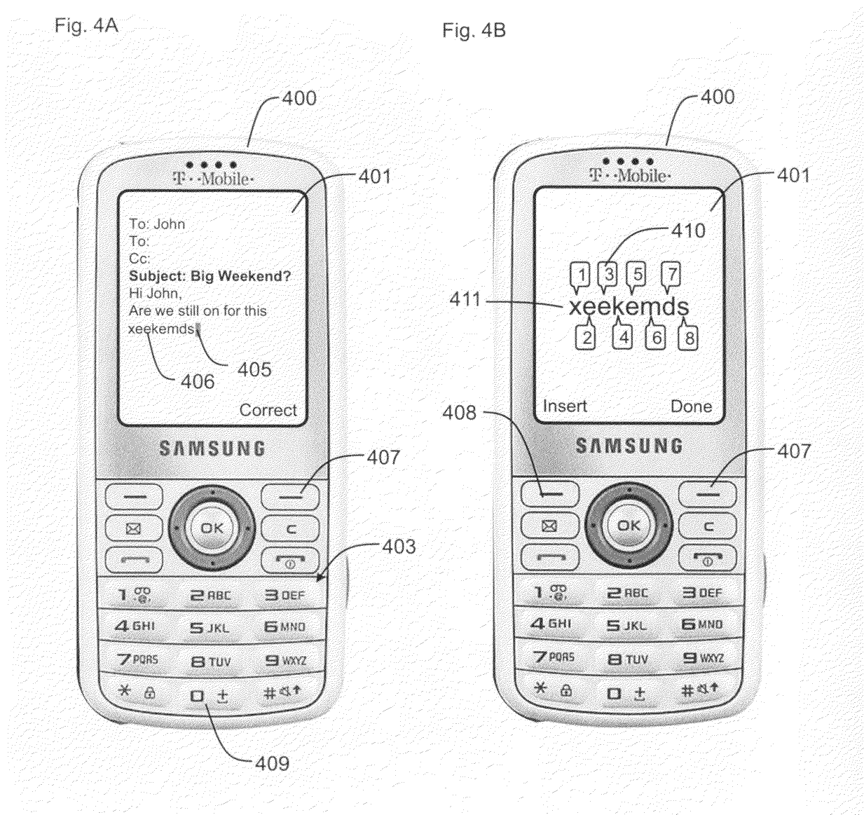

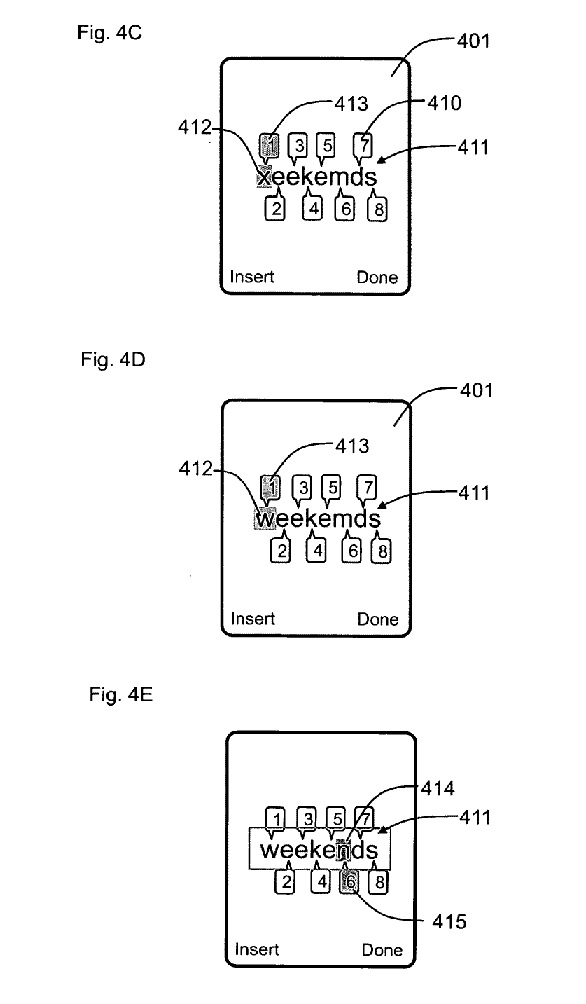

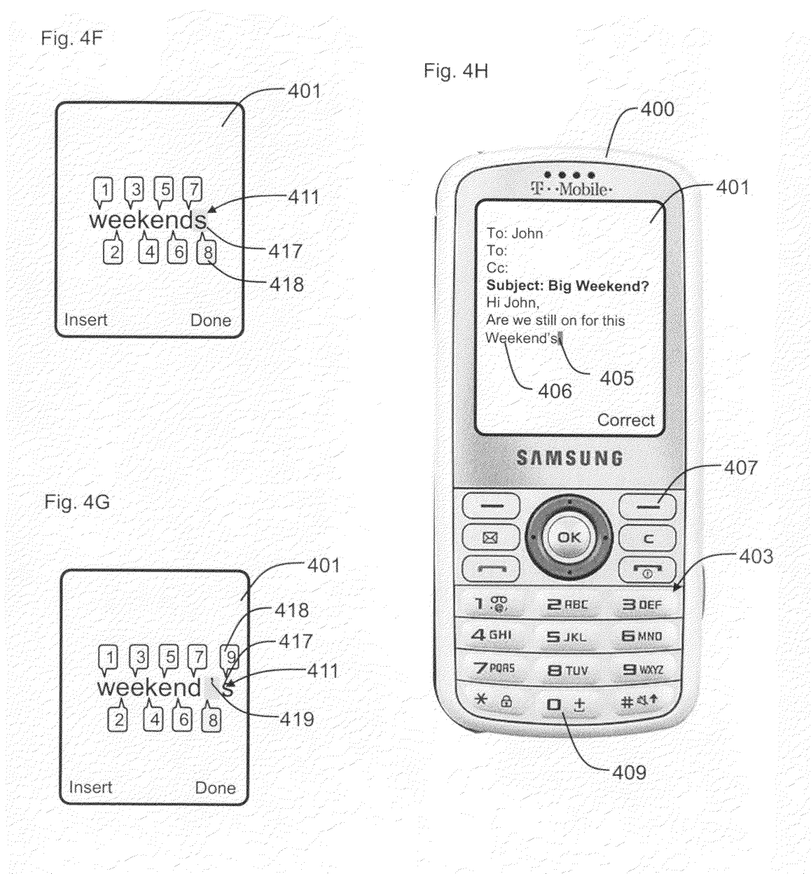

In correction mode, there is optionally one or more buttons (virtual or real) for selecting another word for correction than the word currently selected. As shown in FIGS. 3B-3C, virtual button 330, which is labeled with a leftward pointing arrow, allows the user to select for correcting the word previous to the one displayed as CM word 305 (in this case the one partially displayed—i.e., only the first four letters of ‘returned’ are displayed), and virtual button 331, which is labeled with a rightward pointing arrow, allows the user to select for correcting the word after the one displayed as CM word 305 (in this example there is no word after ‘returned’ and in some cases the button 331 would not be displayed). An example of operation is as follows: if the user wants to correct the word ‘for’, which appears in the text being entered two words prior to ‘returned’, the user would press the virtual button 330 twice. The selected word would be displayed as the CM word as described elsewhere. If after finishing the correction of one word, the user wants to correct another word, the user can use these buttons 330 and 331 to select another word, keeping any corrections already made to the previously selected word. This is especially useful in the embodiment described in conjunction with FIGS. 4A-4H. Buttons or other means for selecting alternate or additional words to be corrected while in correction mode can be incorporated into any of the embodiments described herein.

There is only one error among the first four characters of the word 303—when the UI key was pressed, the software guessed a ‘u’ instead of an ‘i’. To correct an incorrect character among those displayed in the CM word 305, the user first indicates the character to correct by pressing the key associated with the incorrect character, which in this case is virtual key 314 labeled ‘i’ and is the fourth of the keys in CM word 305 because it is the fourth character in the word 303. FIG. 3C shows the text entry and correction portion of the display 301 after the fourth key in CM word 305 has been pressed and selected. Virtual key 314 is highlighted to show that it is selected.

Pressing one of the virtual keys of CM word 305 causes that character to be selected for changing. However, since each key of the SureType keyboard enters only two characters, the software can make the correction without any more input; in other words, since the ‘u’ was wrong, the correct character must be the other character entered using the UI key, or ‘i’. Sometimes, however, the wrong key is pressed, and neither of the characters entered using the key pressed is correct. If the wrong key was pressed (i.e., the user actually meant to press a key other than the UI key), once the key 214 is selected, the user can use the keyboard 304 to change the new incorrect character (the ‘u’ has already been changed to an ‘i’) to another character. If after a key of keyboard 304 is pressed to replace the new incorrect character (i.e., the ‘i’) the character is still wrong, the user can press the selected key in CM word 305 to change it to the other character entered using that same key. CM mode can operate using predictive text algorithms, or not.

Once all characters in the CM word 305 are correct, the user exits correction mode by pressing the CM key 302 or by some other means that can be provided. Upon returning to text entry mode, only the correct characters of the word 303 are shown, as is illustrated by FIG. 3D which shows a view of the text-entry portion of the display 301 of device 300 immediately after correction mode is exited. The word 303 no longer is ‘returned’ but has been changed to ‘reti’ and the cursor 307 is immediately following the word just corrected 303, awaiting the next character to be entered.

An alternate mode of operation for correction mode of the text entry software is described with reference to FIG. 3A and FIGS. 3E to 3J (FIGS. 3F-3J show only the touch screen display 301 and a portion of the SureType keyboard 304). The following example of operation used to illustrate the invention is intended to be illustrative of one possible embodiment (as are all examples herein); there are many variations possible in the operation of correction mode that will be obvious to those skilled in the art. In this example, the user wants to enter ‘retirement’ but has entered ‘returned’ instead by selecting the wrong word from a list of possibilities, and now wants to make a correction. In this second mode of operation for correction mode, all of the characters of the word to be corrected 303 are displayed as part of the correction mode word 315. Each character in the word to be corrected is assigned to a separate virtual key of the set of virtual keys that make up the correction mode word 315, with the keys in word order and labeled with the character. The word ‘returned’ is too long for the CM word 315 to fit on one line, so it is wrapped around into two lines.

The word 315 can be displayed with all character keys having the same format or with the characters actually resulting from keystrokes (in this case, the first four characters were guessed from actual keystrokes) highlighted in some way. In this example, illustrated in FIG. 3E, after the text entry software begins running the correction mode routines (after the user activates correction mode by pressing the CM key 302, pressing a word in the text field, or by some other means), the characters of the word selected to be corrected 303 are displayed uniformly as individual virtual keys in their proper word order. In this embodiment, an insert INS key 316 is displayed on the touch-sensitive display 301 after CM mode is activated. In FIG. 3E it is in the lower left-hand corner of the non-keyboard part of the display 301 above the keyboard (above the QW key) and the CM key 302 is in the lower right hand corner of the part of the display 301 not displaying the keyboard just above the OP key.

In this embodiment, the correction mode software assumes that all characters preceding the currently selected character in CM word 315 (and the word 303) are correct, so the user should start correcting from the beginning of the CM word 315. FIG. 3F, which is a view of the non-keyboard portion of display 301 only, shows the display after the user has selected the fourth character (the ‘u’) by pressing on virtual key 321 in CM word 315. The CM software automatically assumes that the correct character should be ‘i’ since that is the only other character entered using the UI key, and makes the change. The CM software also highlights the first four characters of the CM word 315, ‘r’, ‘e’, ‘t’, and ‘i’ (was ‘u’) to indicate that they are now assumed to be correct. It also shows a bold outline around the fourth character 321 to indicate that it is selected. If ‘i’ was not the correct character, the user could use the keyboard 304 to enter the correct character or delete the character, or could use the INS key 316 to insert a new fourth character.

Since the correction made by the software of the fourth character 321 is correct, the user selects the next incorrect character in the CM word 315 to correct, which is the sixth character/key in CM word 315, the ‘n’ in ‘returned.’ The CM software assumes that the ‘n’ is incorrect and automatically changes it to ‘b’, the other character entered using the same BN key. The first six characters/keys of the CM word 315 are now highlighted and the sixth key 322 has a bold outline, indicating that it is selected. This is illustrated in FIG. 3G. Since the new character ‘b’ is also incorrect, and since the next character, the ‘e’, is, the user deletes the current sixth character, the ‘b’, using the keyboard 304. Now only the first five characters in the CM word 315 are highlighted, and the fifth character 323, the ‘r’, has a bold outline to indicate that it is the selected character.

The new sixth character 323, the second ‘e’ in ‘retired’, the current CM word 315, is now correct, since the user wants to enter ‘retirement.’ The user would like to indicate that the ‘e’ 323 is the last correct character in the CM word 315 and return the word ‘retire’ to text entry mode. In this example embodiment, when the user exits CM mode and returns to text entry mode, only those characters indicated as correct are returned to text entry as the corrected word. There are two ways the user can return the word ‘retire’ to text entry mode in the current embodiment example. The first way is to press the new sixth character 323 twice, once to select it, once to correct the CM software's automatic change of the ‘e’ to ‘r’, and then press the CM key 302 to return the word ‘retire’ to text entry. FIG. 3I shows the display after the two presses of the sixth key 323 and before the pressing of the CM key 302. The other way is to press and hold the sixth character/key 323 to indicate both that the selected character/key (i.e., the one being pressed) is the last correct character in the CM word 315 and that the user wants to return to text entry mode with the correct characters only (the characters in the CM word 315 after the sixth character 323, in this case the ‘d’, are dropped). FIG. 3J shows the display 301 after CM mode is exited and text entry mode reactivated. The word 303 now contains only those characters of the CM word 315 that were indicated to be correct—the first six characters or ‘retire’. In another mode of operation, all the characters remaining in CM word 315 when the CM key 302 is pressed will be returned to replace the originally selected word 303.

Another mode of operation is possible. This mode is illustrated in FIGS. 3K-3L. In this mode of operation, users can enter a correction mode wherein the entire contents of the currently active text field, or at least some portion thereof, will be displayed on the touch-sensitive display with each character thereof, including line breaks and spaces, displayed as in individual virtual key. The text/keys are wrapped around to form multiple lines. This is shown in FIG. 3K where the contents of the currently active text field are displayed as a set of virtual keys 353, each labeled with a different character in its order in the text field. The currently active text field contains: “Hi John, Are we still on for this returned”. There is a line break after “John,”.

Referring to FIG. 3A, when the user presses the CM button 302, the device 300 activates correction mode. The display then shows a portion 351 of the characters in the active text field (all if there are less than the number of virtual keys available in the selection screen shown in FIG. 3K), with each of those characters labeling, in order, a separate key (as shown in FIG. 3K). The selection screen also includes two keys, Up 355 and Down 357 which allow the user to scroll through the text 5 characters at a time (this is limited by the number of keys in each line) (in an alternate embodiment, the scrolling could be one complete word or line at a time, whichever is more). There is also a CM key 356 that can be used to exit correction mode and return to text entry. The user then selects a character to be corrected (in this case it is the ‘u’ 353 in ‘returned’) by pressing on the appropriate virtual key.

When a character 353 is selected to be corrected, correction mode in this mode of operation can switch to displaying just the word in which the selected character 353 is located (this would be the same as what is displayed in FIG. 3E), or several lines of keys 352, including those displaying all the characters in the word containing the selected character 353, can be displayed. The user then corrects the word as described elsewhere, using the keyboard 304 which is now displayed. Pressing the CM key 302 does not return the user to text entry mode, but instead returns the user to the screen shown in FIG. 3K. The user has to press the CM key 356 to exit correction mode entirely and return to text entry. This mode of operation makes it easy for a user to correct a larger portion of text by allowing the user to see select characters in multiple words from a single screen.

The preceding examples of operation of text entry software implementing the novel text correction method described above are just three of many possible variations of the operating rules of the software implementing correction mode. These different variations may be set by the software designers and coders or may be user configurable.

FIGS. 4A-4H provide an example showing how the novel method of correcting text can be implemented on a handheld computing device 400 (shown is a cell phone) comprising a display screen 401, and a 12-key phone keypad 403. The display 401 can be touch-sensitive, but does not need to be.

An example is provided to illustrate how the novel method is implemented. In the example, the user is entering text, and has just entered the word ‘xeekemds’ (see FIG. 4A); the user intended to enter ‘weekend's’ but made errors in text entry. To correct the word, the user positions the cursor 405 in or just after that word, and then presses the right soft key 407, which is labeled ‘Correct’ during text entry, to activate or enable the software subroutines or programs implementing the novel text correction method.

FIG. 4B shows the first screen or window of text correction mode. Upon entering text correction mode, the word to be corrected 406 is displayed as a correction mode word 411 on the screen 401 with a number tag 410 linked or otherwise visually associated with each character of the word 411. The characters in word 411 and word 406 are identical and in the same order at this point. Each number tag 410 has a different label (a number or a letter or set of letters) which corresponds to the label found on one of the keys 409 of the keyboard 403. In the example here, the labels are numbers 1-8 (for words with more characters, the labels for the 9^{th} to 12^{th} characters could be 9, *, 0 and #). Alternately, letters could be used such as 1, A, D, G, J, M, P, T, W, *, 0, #, or 1, ABC, DEF, GHI, JKL, etc. The labels inform the user which key of keyboard 403 to press to select the character in word 406 associated with it. Keys on the device other than the 12 keys of the phone keypad 403 could also be to select characters. The left softkey 408 now operates as an insert key and is labeled ‘Insert’, while the right soft key 407 operates to exit correction mode and is labeled ‘Done’.

For simplicity, some of the figures show only the display 401 and what is displayed on it. Pressing the key indicated by a label 410 selects the character associated with the label 410. The first character 412 in word 411 (and word 406) is incorrect and should be a ‘w’ instead of an ‘x’. To correct it, the user presses the 1 key. FIG. 4C shows that the first character has been selected by pressing the 1 key; selection in this example is indicated by highlighting the character 412 and its associated label 413, although it could be indicated by other means such as underlining, bold, a circle around the character or other means. Once a character in word 411 is selected, the user can use the keyboard 403 to change it. In one variation, the software assumes that the user pressed the correct key when entering the character the wrong number of times, and the software will automatically guess another character entered by that same key (perhaps the most frequently used character or the most likely to appear in that word or in that position of a word or the character entered using one more or one less tap of that key). In the example here, selection of a character does not change it. FIG. 4D shows the display 401 after the first character 412 has been changed to a ‘w’ using the keyboard 403 (not shown). The first character 412 and its associated label 413 are still highlighted, indicating that the character 412 is still selected.

The sixth character 414 is also incorrect. To correct it, the user presses the key of keyboard 403 indicated by the label 415 linked to the sixth character 414, which is the 6 key, and then the user operates the appropriate key of the keyboard 403 in the appropriate way to enter the correct character, in this case an ‘n’. FIG. 4E shows the display after the sixth character 414 has been selected and corrected.

If a character is missing in the word, the user selects the character immediately after where the character should be and presses the Insert labeled soft key 408 (not shown). This causes a blank character or space to be inserted into the word 411 immediately in front of the selected character, with the newly inserted character highlighted as selected. FIGS. 4F and 4G illustrate how this would operate in the current example. In FIG. 4F, the eighth character 417 ‘s’ of word 411 has been selected by pressing the key of keyboard 403 (not shown) indicated by its label 418. Both label and character are highlighted. The user presses the Insert labeled soft key (not shown) to insert a space in front of the ‘s’ 417. The newly inserted space is automatically selected. The user can then use the keyboard 403 to replace that space with a different character.

FIG. 4G shows the display 401 which is displaying the results after the user has replaced the space inserted before the s character 417 with an apostrophe 419. Note that the label 418 for the s character 417 has changed from 8 to 9 since after the space is inserted in front of it, since the ‘s’ is now the ninth character in word 411; the newly inserted space, and the apostrophe 419 that subsequently is entered to replace it are now the eighth character in the word 411 and are therefore labeled 8. Henceforth, to select the s character 417, the user presses the 9 key. The word correction algorithm may only allow correction of the first 9 (labeled 1-9) or 10 (labeled 1-9 then 0 for the tenth) or 12 characters (labeled 1-9, then *, 0, #) or some other number of characters, or it may allow any number to be corrected, wrapping the word to be corrected around and adjusting the labeling sequence to allow characters above the number of keys to be selected, such as by pressing the 1 key twice in rapid succession to select the 11^{th} character (i.e., pressing a key twice in rapid succession selects the nth plus 10 character where n is the number of the key [0 is the 10 key so pressing it twice in rapid succession selects the 20^{th} character) in a setup where only the number keys are used to select characters and the characters are labeled in order 1 through 9 with 0 being used instead of 10.

Now that the word 411 is correct, the user returns to whatever he was doing when he activated word correction mode (i.e., to whatever application or window into which he entered the word 406). This can be accomplished by pressing the softkey labeled Done or by some other means. The current word 411—weekend's—is then returned to that application or window, and replaces the word 406 that had been selected to be corrected (which was ‘xeekemds’), with the cursor 405 following the word or at the end of the text, depending upon the software's configuration. FIG. 4H is a plan view of the front of device 400 showing only the top portion of it, including the display 401 and what is on the display after returning from correction mode. The word 406 is now “weekend's”. The user can continue text entry. The right softkey 407 is now once again labeled ‘Correct’ and can be used to enter correction mode.

One issue with newer handheld electronic devices such as the iPod Touch, the iPhone and the BlackBerry Storm is that it can be difficult to make the correct selection because fingers are too big to always press the intended spot on the touch screen. Following are two improvements for entry into computing devices with touch-sensitive display interfaces. The first is an improvement that makes it easier for a user to select a specific menu entry or item in a displayed list. The second makes it easier to select the correct key of a virtual keyboard or any other defined field or location on the touch-sensitive display.

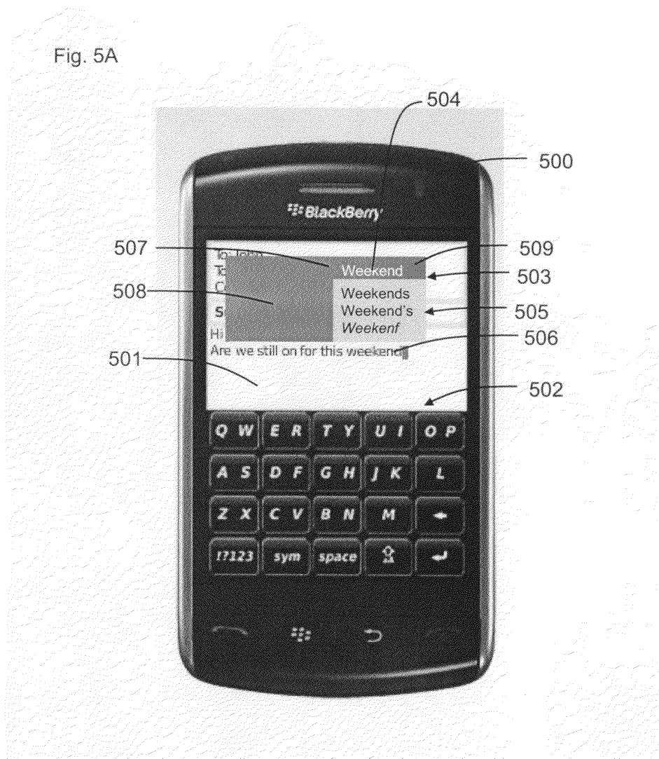

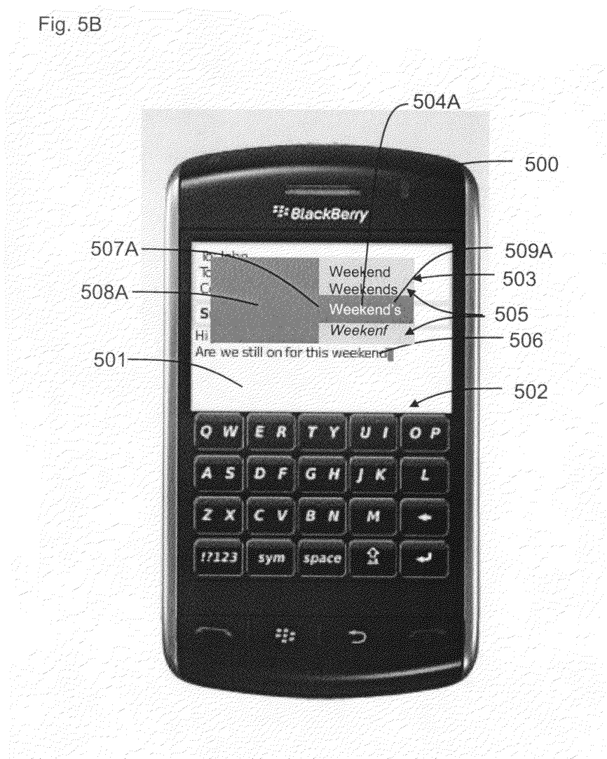

The following example applies the first improvement to text entry although it can equally usefully be applied to the act of selecting an option from a menu. FIG. 5A is a front plan view of a handheld computing device 500 (pictured is a BlackBerry Storm) having a touch screen display 501 interface. The display 501 is currently showing a virtual keyboard 502 that is being used to enter text. A predictive text algorithm is running as part of the text entry software, and a list 503 of guesses by the predictive text algorithm is shown as a drop-down menu. The first guess (in this case the word “Weekend” which is the same as the word 506 displayed in the text entry field) in the list 503 is highlighted to distinguish it from the other guesses 505 (words in this case, of which there are three) (other methods of indicating the current selection can be used such as bolding, underlining or circling the selection). This indicates that this word (or guess) is pre-selected for entry.

Many touch screen interfaces allow a user to pre-select a word in the list of guesses (or drop-down menu) prior to actually entering (selecting) it by touching its representation on the touch screen; in this case, the text entry software has selected the top word automatically. Words or menu options are typically pre-selected by light pressure on the desired selection, while entry or final selection of a word or option is accomplished by heavier pressure on the desired selection; in some cases, such as the BlackBerry Storm, an electromechanical switch underlying the touch-screen must be operated.

When a word or menu option is pre-selected, a virtual button is created which incorporates that word or option. Typically this is done by highlighting the word or option in some way (e.g., placing a colored rectangle around it or making it bold). The user typically has to press directly on this virtual button to operate it. Because these virtual buttons are typically small and thin relative to a finger, this can be difficult, and often the user inadvertently pre-selects another option or guess when trying to press down on the selected option or word, thereby creating a new virtual button for the inadvertently preselected option or word which they then engage or actuate, thereby entering the wrong word or choosing the wrong option. Unfortunately, fingers are big compared to these typical virtual buttons in lists of words or menu options, and it is easy for the user to miss the current virtual button.

In the current improvement, to make it easier for a user to select the option or word that has been pre-selected, the virtual button 507 that is created for the pre-selected word 504 (‘Weekend’) incorporates a large area 508 of touch-sensitive display 501 adjacent to the list 503 of words (or menu options) which functions as part of the virtual button that can be pressed to select (enter, choose) a word (or option) from the list 503. This large area 508 is contiguous to the virtual button 509 which overlays or surrounds the pre-selected word 504. The user can press on any part of button 507 to enter the pre-selected word ‘Weekend’ into the text field to replace the current word 506 (or if list 503 was a menu, to choose the preselected option). Area 509 (and 509A) is preferably large enough to make it easy for a user to accurately and consistently operate it successfully with any finger (i.e., intention to press the button 507 is consistently converted into the actual pressing of button 508). An area of 1 cm̂2 or larger would be sufficient, although areas somewhat smaller could also serve the purpose, especially if the area is sufficiently separated from other selectable items on the display 601. In general, the larger area 508 is, the easier it will be to operate virtual button 507 without error. One advantage of having area 509 and 509A to press when entering or choosing a word or menu option is that the user can see the list or menu. Another is that the user is unlikely to inadvertently preselect and enter the wrong word or menu item, even if he or she somehow misses the large area 509 or 509A.

In FIG. 5B, the user has scrolled down the list 503 of words or options to pre-select another word 504A (“Weekend's”). A virtual button 507A has been created, which incorporates both a section 509A surrounding the pre-selected word as is typical with the virtual buttons created by pre-selecting a word or option and a large section 508A contiguous to it. A user can press anywhere within the bounds of virtual button 507A (the area of touch-sensitive display 501 that is demarcated as button 507A in some way, such as by highlighting as in FIG. 5B) to enter or actually choose the preselected word or option.

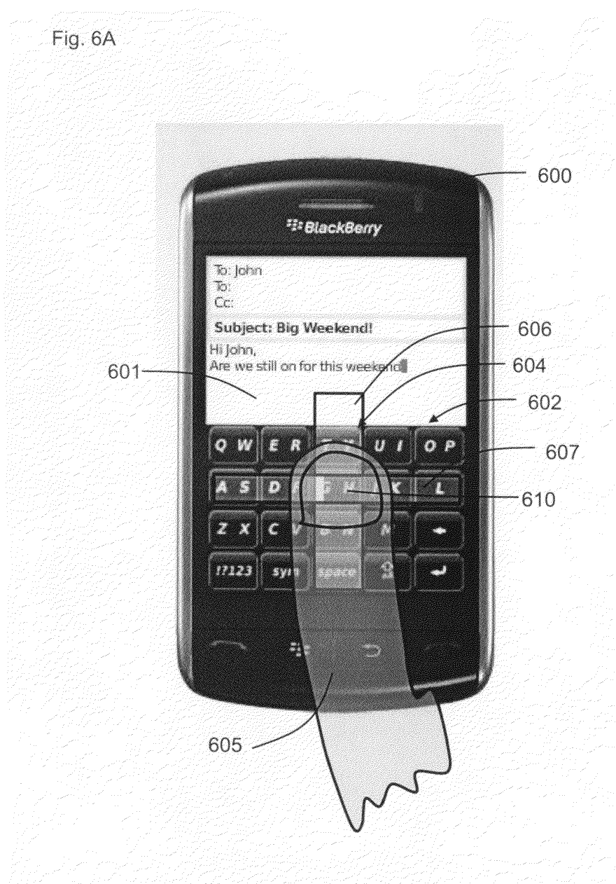

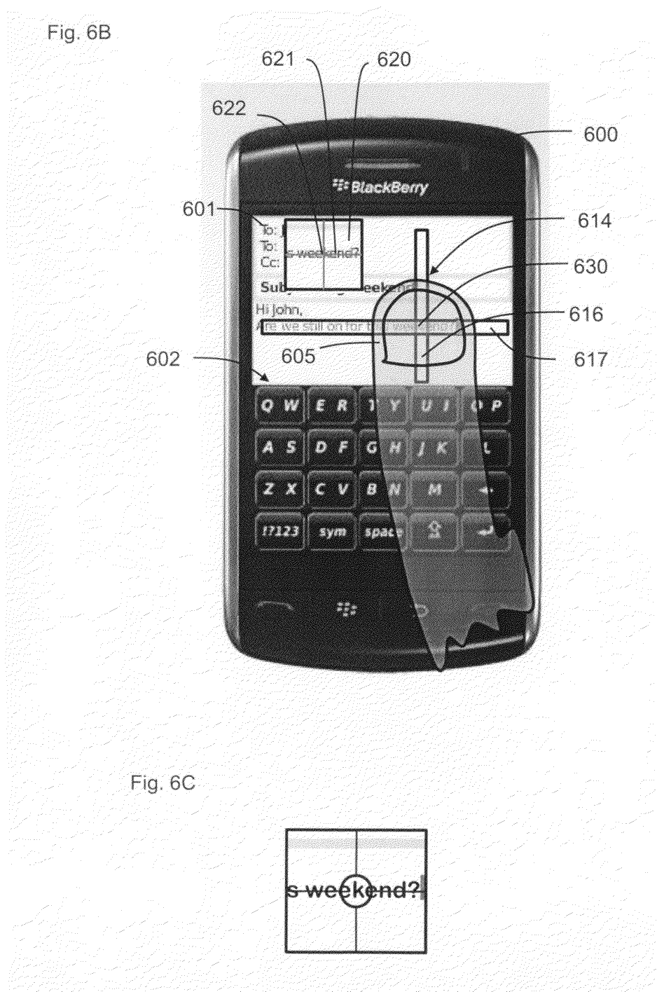

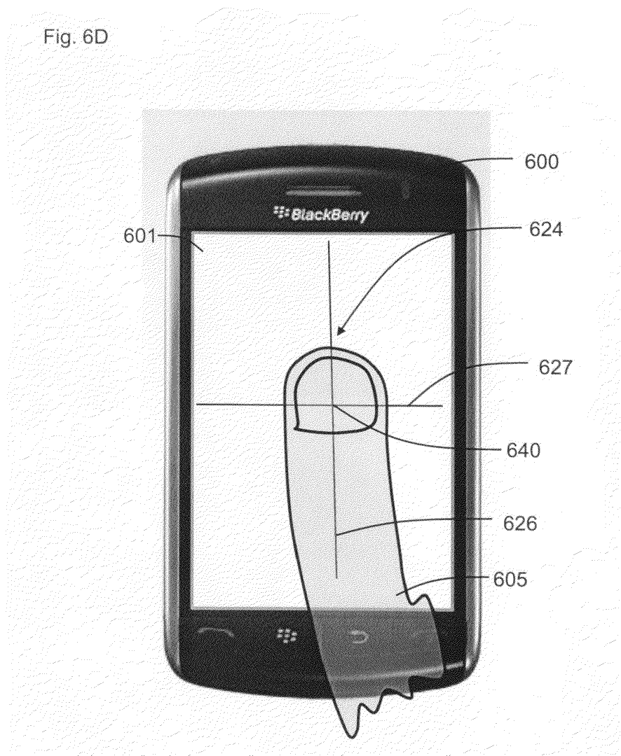

The second improvement for text entry is described in conjunction with FIGS. 6A-6D. FIG. 6A is a front view of a handheld computing device 600 (shown is a BlackBerry Storm) with a touch-sensitive display 601 interface. A user's finger 605 (shown in outline so the keyboard is visible below it) is in the process of trying to type or enter a character using the virtual keyboard 602. In order to make it easier for a user to press the correct key, a touch-screen entry aid 604 is created on the display 601 whenever the virtual keyboard 602 is touched. The aid 604 shown in FIG. 6A is cross shaped, with a vertical element 606 and a horizontal element 607. The vertical element 606 extends above and below, and the horizontal element 607 extends to the left and right of the virtual key that has been touched (in this case, the GH key of the SureType keyboard 602), both extending sufficiently to not be covered by the finger 605.

The purpose of the aid 604 is to make it easy for a user to determine where on the touch-sensitive screen his finger is contacting, and in particular, which virtual key the software running the handheld device 600 has determined that the user is pressing. A cross-shaped graphic such as touch-screen entry aid 604 works well because a user can easily intuit at which key the vertical 606 and horizontal 607 arms intersect (at point 610), and since users already know where the key they are trying to press is, the user will know if their finger is on the correct key. However, other shapes and orientations can also function well provided the graphic 604 consists of elements which intersect or imply an intersection so that the user can identify a particular point on the touch screen or keyboard as the implied intersection of those elements. The preferred use of a graphic aid such as graphic 604 is when the finger is contacting a position of the touch sensitive display that is within a virtual keyboard.

Aid 604 shown in FIG. 6A is semi-transparent so that the user can still see the keys behind it, although it can be solid. The graphical aid 604 is symmetrical around the key, but it does not need to be. The vertical element 606 is shaped to be the width of a key so that the user can easily determine which column of keys his finger is touching, and the horizontal element 607 is the height of a row of virtual keys so that the user can easily determine which row of keys his finger is touching. The key that is being touched by the finger will be the key in that row and column of keys. The space 610 created by the intersection of the two elements 606 and 607 is the size of a key.

The current approach used by some touch-screen virtual keyboards is to create a circular glowing area around the virtual key being touched. The BlackBerry Storm uses this approach. There are two problems with this: first, it is harder to find the center of a circle, especially one mostly covered by a finger, than it is to find the intersection of two linear elements; and second, increasing the size of a circular graphic or highlighted area greatly increases the area obstructed partially or fully by the graphic. The difficulty in identifying the center of a circular graphic or highlighted area makes it difficult to identify exactly where the touch point is both in the vertical and the horizontal directions, making such an approach not fully effective even in determining whether the finger is pressing a virtual object as big as a virtual key, let alone smaller objects on the display. It is also difficult to use this approach to identifying where a finger is in contact with the touch-sensitive display for areas of the screen other than virtual keyboards. Another approach used by makers of handheld devices using virtual keyboards on a touch-screen is to display a graphic generally connected to the key the finger is touching but extending beyond the area covered by the finger and labeled with the label of the key. The iPhone uses this approach. This approach works fine for virtual keyboards, but not for elsewhere on the touch screen, such as in a text entry field or a displayed web site to press a link. In these cases, the user's finger may block the entire object to be pressed or selected, and the user will not be able to determine whether his finger is in the right location or not (often links in a web page displayed on a small screen and words in a text field are very small and very close together).

FIG. 6B shows a front view of handheld device 600 where the user is now moving his finger in the text field to select a word or letter. A cross-shaped graphical aid 614 with thin horizontal arm 617 and vertical arm 616 intersecting at the point of contact between finger 605 and the display. Aid 614 is not symmetrical, with the vertical element 616 extending further above the intersection point 630 than below and the horizontal element 617 extending further to the left of the intersection point 630 than to its right. The horizontal and vertical elements can also be lines. The point of intersection 630 of the two elements 616 and 617 is still clear. Although the user cannot see what is beneath his finger, if he can remember where the object to be touched and pressed is located, he can determine whether his finger is touching there by using the elements 616 and 617 of the aid 614 to determine whether the point of intersection 630 coincides with where he remembers the object to be touched to be.

In one embodiment, an insert window 620 graphic shows a part of the image on the display that is adjacent to the point of contact between the finger 605 and the display 601, and which may, at least in part, be blocked by the finger 605. The insert 620 also indicates the specific point of contact 622 that has been calculated or otherwise determined by the software controlling the touch-sensitive display 601. In the embodiment shown in FIG. 6B, the point of contact 622 is indicated by a pair of intersecting perpendicular lines 621 which intersect at the point of contact 622. The intersection is at the character that is preselected (in this case ‘k’) and will be selected if the user presses hard enough on the touch sensitive display 601. FIG. 6C shows another embodiment of the insert where the character preselected is highlighted by circling the character.

Graphic aids such as 604, 614 and 622 can be used to indicate the point of contact anywhere on a display and are not limited to working with text. For example, they can indicate where on a virtual map or which item in a menu a finger is touching. The item being touched can be highlighted, on both the main display and in the insert.

The combination of the positioning aid 604 and the insert window 620 make it very easy for a user to determine whether he or she is pressing the desired point on the touch screen 601. The aid helps the user locate his finger in approximately the right location, and the insert 620 enables the user to view the part of the display that is obscured by his finger and press exactly the right location. The positioning aid 604 and/or insert window 620 (the insert can be separately implemented or not implemented at all) are both implemented in the software running the touch-sensitive interface and do not affect the way the interface functions; they simply make it easier to use.

The insert window 620 graphic can show a magnified version of the part of the display 601 surrounding the point of contact 622 (the point 622 shown in the insert is actually located under the finger 605 at the intersection 630 of the vertical 616 and horizontal 617 elements of the aid 614). The insert window 620 can be rectangular or circular or any appropriate shape. It should be sufficiently large to be useful in determining whether the point of contact is at the right point (here it is at the ‘k’ in the word ‘weekend’). The insert can be displayed anywhere on the display 601 that will be visible to the user (the upper corners are good locations), and can be of any appropriate size.

To create the insert window graphic 620, the software program simply copies the pixels from the area to be displayed (i.e., some part of the display surrounding the point of contact between the finger and the display) to another part of the image sent to the display. Whether the insert window will be displayed when a finger is in contact with the display can be a user option. Also, the insert window may only be displayed after some user action is performed, such as pressing a particular key, virtual or real, or after the user's finger has been in contact with the touch sensitive display for at least some predetermined length of time.

The touch-sensitive display's software can be configured so that positioning aids 604 and 614 will move as the point of contact moves (thin intersecting elements may be appropriate for this), or to move only when the point of contact leaves a specific area of the display. The latter case is described above where the point of contact of the finger is within the area of the virtual display 602 and the arms 606 and 607 of aid 604 move only when the point of contact moves from one row or column of keys to another, or leaves the area of the keyboard altogether. In FIG. 6A, the aid 604 shows where the key with which the finger is in contact is located, and if there was an insert showing an area under the finger 605, it would show that key. In the example shown in FIG. 6B, where the point of contact is in a text entry field, the horizontal element 617 may correspond to a row of text and only move when the finger is in contact with a different row, and the vertical element may correspond to a particular character and may move only when the finger is in contact with another character. For web pages or other types of displayed images, it may be appropriate to do something similar or it may be preferred that the vertical and horizontal elements of the positioning aid 624 are simply lines as in FIG. 6D. In FIG. 6D, positioning aid 624 consists of a vertical line 626 and horizontal line 627 which intersect at the calculated point of contact 640 between the finger 605 and the touch-sensitive display 601.

To create the insert window, the software for the touch-sensitive display's user interface calculates the point of contact between the user's finger and the display, then grabs or copies that portion of the display centered or roughly centered on that point of contact and which fits within the chosen insert; it then creates a graphic to show the actual point of contact within the image (this can be crossing lines or a small outline of the area [like a bullseye]). If there is any magnification of the image in the insert, the software calculates what portion of the area of the display around the point of contact will, upon magnification, fill the insert, and then grabs that information and magnifies it. The insert may be defined to contain X pixels to the left and right, and Y pixels above and below, the point of contact, or any pixels within Z of the point of contact. The pixels (i.e., the parameters of the pixels: intensity, color, etc.) in the insert can be exact duplicates of the pixels surrounding the point of contact, or can be modified, such as by making them semi-transparent or magnifying them. The insert window can be a separate window displayed on top of or overlaid on the displayed image, or can be incorporated directly into the displayed image (the displayed image is that image that would otherwise be displayed on the screen. The positioning aid can be overlaid on the displayed image or incorporated into it.

It is well-known how to program software to create highlighted areas or graphical elements on displays, and how to create inserts or windows. The above also describes a method of visually indicating the point of contact between an object, such as a finger, and a touch-sensitive display comprising making contact with the touch-sensitive display, optionally determining the type of object at the point of contact and selecting a graphical aid appropriate to that type of object, and displaying a graphical aid consisting of at least two elements which intersect, or imply an intersection, at the point of contact or at the object at the point of contact. The graphical aid can be lines, rectangles with volume or other shapes.

Described herein is a computing device having a touch-sensitive display user interface on which are displayed lists or menus of items that can be user selected by pressing on the item comprising an oversized virtual button that can be used to select or enter a pre-selected item in the list or menu.

Also described herein is the computing device described above wherein the oversized virtual button comprises a virtual button formed around the preselected item in the list or menu and a contiguous or adjacent area that operates as part of said virtual button for choosing or entering the preselected item.

Also described herein is touch-sensitive display software comprising a routine that increases the size of the virtual button created when an item or entry or option in a list or menu is touched by creating an extension of that virtual button adjacent to or contiguous to, but to the side of said virtual button.

Also described herein is a computing device having a touch-sensitive display user interface comprising a graphical aid which enables a user to determine the point or area of contact between his finger and the touch-sensitive display.

Also described herein is the computing device with a touch-sensitive display user interface described immediately above further comprising an insert displaying some portion of the image on the display surrounding the point of contact between a user's finger and the display.

Also described herein is user input software for a computing device having a touch-sensitive display user interface comprising a routine for creating a graphic comprising a plurality of elements which intersect or appear to intersect at the point of contact between the finger and the touch-sensitive display.

As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of’ and “consisting essentially of’ are closed or semi-closed transitional phrases, respectively, with respect to the claims.

The inventions herein are not limited in their application to the details of construction and the arrangement of components set forth in the preceding description or illustrated in the drawings.

The inventions are capable of embodiments and of being practiced or of being carried out in various ways beyond those exemplarily presented herein.

Having now described some illustrative embodiments of the invention, it should be apparent to those skilled in the art that the foregoing is merely illustrative and not limiting, having been presented by way of example only. Numerous modifications and other embodiments are within the scope of one of ordinary skill in the art and are contemplated as falling within the scope of the invention. In particular, although many of the examples presented herein involve specific combinations of method acts or system elements, it should be understood that those acts and those elements may be combined in other ways to accomplish the same objectives.

Further, acts, elements, and features discussed only in connection with one embodiment are not intended to be excluded from a similar role in other embodiments.

It is to be appreciated that various alterations, modifications, and improvements can readily occur to those skilled in the art and that such alterations, modifications, and improvements are intended to be part of the disclosure and within the spirit and scope of the invention.

Moreover, it should also be appreciated that the invention is directed to each feature, system, subsystem, or technique described herein and any combination of two or more features, systems, subsystems, or techniques described herein and any combination of two or more features, systems, subsystems, and/or methods, if such features, systems, subsystems, and techniques are not mutually inconsistent, is considered to be within the scope of the invention as embodied in the claims.

Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Those skilled in the art should appreciate that the parameters and configurations described herein are exemplary and that actual parameters and/or configurations will depend on the specific application in which the systems and techniques of the invention are used.

Those skilled in the art should also recognize or be able to ascertain, using no more than routine experimentation, equivalents to the specific embodiments of the invention. It is therefore to be understood that the embodiments described herein are presented by way of example only and that, within the scope of the appended claims and equivalents thereto; the invention may be practiced otherwise than as specifically described.

What is claimed:

1. A method of correcting a word entered into a computing device having a display using a text entry program comprising the steps of:
(a) selecting a word to be corrected from among one or more words displayed on the computing device display screen;
(b) entering text correction mode and leaving the text entry program;
(c) displaying the text characters comprising the word selected for correction so that each of the text characters in the word can be individually selected by a user;
(d) selecting a text character;
(e) making a correction by changing the text character selected, deleting the text character selected or inserting a text character adjacent to the text character selected;
(f) repeating steps (d) and (e) as needed to change the word selected for correction to a corrected word; and
(g) exiting correction mode and returning to the text entry program, and replacing the word selected to be corrected with the corrected word.

2. The method of claim 1 wherein step (c) of displaying the text characters comprising the word selected for correction so that each of the text characters in the word can be individually selected by a user comprises displaying each text character comprising the word selected for correction in word order as a separately selectable virtual button or key labeled with the text character.

3. The method of claim 2 wherein the display of the computer device is a touch sensitive display, and selecting a text character comprises pressing the separately selectable virtual button for that text character.

4. The method of claim 2 wherein selecting a text character comprises pointing at said separately selectable virtual button with a mouse cursor and pressing a selection button of the mouse.

5. The method of claim 1 wherein displaying the text characters comprising the word selected for correction so that each of the text characters in the word can be individually selected by a user comprises visually associating each text character of the word selected for correction with a different key of a keyboard of the computing device, and wherein selecting a text character comprises pressing the key visually associated with that text character.

6. The method of claim 5 wherein the computing device further comprises a keyboard fixed in position relative to the display, and visually associating a text character in the word selected for correction comprises displaying each text character in word order above a different key in the first row of keys of the keyboard.

7. The method of claim 1 wherein displaying the text characters comprising the word selected for correction so that each of the text characters in the word can be individually selected by a user comprises displaying each text character comprising the word selected for correction so that the text character is visually associated with a number from at least 1 to 9, and wherein selecting a text character comprises pressing a number key corresponding to the number associated with the text character being selected.

8. The method of claim 1 wherein selecting a text character to be corrected provides sufficient information for the computing device to automatically make a correction.

9. The method of claim 8 wherein the computing device further comprises a keyboard having a plurality of letter keys, each letter key operative to enter no more than two different letters.

10. The method of claim 1 wherein the text character selected when correction mode is exited is the last correct character in the word.

11. The method of claim 10 wherein the corrected word consists of last correct text character in the word and each preceding text character.

12. The method of claim 1 wherein if no word to be corrected has been selected in step (a) then the last word entered is selected as the word to be corrected upon entering correction mode.

13. A computing device comprising a means of entering correction mode during text entry.

14. The computing device of claim 13 wherein the means of entering correction mode comprises a correction key.

15. The computing device of claim 14 wherein said correction key is one of a virtual key on a touch-sensitive display, a soft key, or a key in a keyboard.

16. A text entry program for a computing device comprising correction mode functionality.
